(19) United States
(12) Patent Application Publication
(10) Pub. No.: US 2016/0333232 A1
(43) Pub. Date: Nov. 17, 2016

(54) ELECTRICALLY CONDUCTIVE ADHESIVE TAPES AND ARTICLES THEREFROM

(71) Applicant: 3M INNOVATIVE PROPERTIES COMPANY, St. Paul, MN (US)

(72) Inventors: Jeongwan Choi, Kyonggi-Do (KR); Jeffrey W. McCutcheon, Baldwin, WI (US)

(73) Assignee: 3M INNOVATIVE PROPERTIES COMPANY, St. Paul, MN (US)

(21) Appl. No.: 15/112,595

(22) PCT Filed: Jan. 21, 2015
(86) PCT No.: PCT/US2015/012141

§ 371 Date: Jul. 19, 2016

Related U.S. Application Data
(60) Provisional application No. 61/931,361, filed on Jan. 24, 2014.

(51) Int. Cl. C09J 9/02; C09J 7/02

(52) U.S. Cl. CPC C09J 9/02; C09J 7/0289; C09J 2467/006; C09J 2433/00

(57) ABSTRACT

An electrically conductive, single-sided tape includes a conductive adhesive layer, which includes a first conductive porous substrate having a plurality of passageways and an adhesive material positioned within at least a portion of the passageways; and a second conductive porous substrate positioned adjacent the conductive adhesive layer. Optionally, the electrically conductive, single-sided tape may include an opaque coating adjacent to a major surface of the second conductive porous substrate. Optionally, the adhesive material may include a plurality of conductive particles dispersed within the adhesive material.

### CROSS REFERENCE TO RELATED APPLICATIONS

This application claims priority to U.S. Provisional Patent Application No. 61/931,361, filed Jan. 24, 2014, the disclosure of which is incorporated by reference in its entirety herein.

### TECHNICAL FIELD

The present invention is related generally to electrically conductive tapes. In particular, the present invention is a conductive single-sided tape having a conductive adhesive layer, which includes a first conductive porous substrate and a second conductive porous substrate. The second conductive porous substrate may include a plurality of fibers and an opaque coating disposed in at least a portion of the interstitial regions between the fibers.

### BACKGROUND

Electrically conductive tapes have numerous constructions and have conventionally been formed using various methods. For example, in one construction, an electrically conductive adhesive tape can be formed by dispersing finely divided silver in a pressure sensitive adhesive and coating the adhesive on an electrically conductive backing. In another construction, a conductive tape is formed with a layer of large conductive particles on the pressure sensitive adhesive. In yet another embodiment, an electrically conductive backing is embossed to have a plurality of closely spaced electrically conductive projections that extend almost through the layer of adhesive. One characteristic common to all of these constructions is that they do not provide reliable electrical connections to very small size contacts.

There is an increasing demand for thinner conductive single-sided tapes which provide reliable electrical connections to very small contacts. This is in part because connections to small contacts are becoming more important for many electronic uses of conductive tapes. Additionally, along with the thinner tapes, there is a need for improved handling and workability to facilitate the mass production required in the electronics industry. Currently, metal foil based tapes are one approach to providing the required conductivity and flexibility of the tape. However, the metal foil can be easily damaged during handling and rework. The foil tapes may also curl when the release liner is removed, making handling difficult.

There is also a growing need in the electronics industry for conductive tapes which have an opaque coating of a specific color, in order to block light, for example, in an electronic display or to match the color of another component of an electronic device. In the case of metal foil tapes, an opaque coating of the desired color may be applied to its surface. However, the coating itself may lead to a loss in electrical conductivity, particularly through the thickness of the electrically conductive tape. Additionally, the adhesion of the coating may fail, due to flexing or wrinkling of the foil, causing coating loss and unacceptable aesthetics. Thus, there is a need for thin, electrically conductive, single sided tapes that provide reliable electrical connections to very small contacts, provide good workability and handling characteristics and also provide color matching or light blocking characteristics while maintaining the required electrical conductivity.

### SUMMARY

In one embodiment, the present disclosure relates to an electrically conductive, single-sided tape including a conductive adhesive layer, which includes a first conductive porous substrate having a plurality of passageways and an adhesive material positioned within at least a portion of the passageways; and a second conductive porous substrate positioned adjacent the conductive adhesive layer. Optionally, the electrically conductive, single-sided tape may include an opaque coating adjacent to a major surface of the second conductive porous substrate. Optionally, the adhesive material may include a plurality of conductive particles dispersed within the adhesive material.

In another embodiment, the present invention is an electrically conductive, single-sided tape including a conductive nonwoven substrate, an adhesive embedded within the conductive nonwoven substrate and a conductive woven substrate, having interstitial regions between the fibers, positioned adjacent the conductive nonwoven substrate. Optionally, the adhesive may include a plurality of metal particles dispersed within the adhesive. The electrically conductive, single-sided tape may include an optional opaque coating disposed in at least a portion of the interstitial regions between the fibers.

### BRIEF DESCRIPTION OF THE DRAWINGS

FIG. 1A is a cross-sectional view of a first exemplary electrically conductive, single-sided tape of the present disclosure;

FIG. 1B is a schematic top plan view of a layer of the electrically conductive, single-sided tape of FIG. 1A;

FIG. 2a is a cross-sectional view of a second exemplary electrically conductive, single-sided tape of the present disclosure;

FIG. 2b is a cross-sectional view of a third exemplary electrically conductive, single-sided tape of the present disclosure;

FIG. 3 is a cross-sectional view of a fourth exemplary electrically conductive, single-sided tape of the present disclosure;

FIG. 4 is a schematic view of a test panel used for measuring the x-y-axis electrical resistance of a conductive, single-sided tape; and

FIG. 5 is a schematic view of a test panel used for measuring the z-axis electrical resistance of a conductive, single-sided tape.

FIG. 6 is a photograph of a test panel used for measuring the x-y-axis electrical resistance of multiple, narrow, small surface area traces.

FIG. 7 is a cross-sectional view of an exemplary assembly of the present disclosure.

FIG. 8 is a cross-sectional view of an exemplary electronic device assembly of the present disclosure.

FIG. 9 is a cross-sectional view of a second exemplary assembly of the present disclosure.

FIG. 10 is a cross-sectional view of a second exemplary electronic device assembly of the present disclosure.

These figures are not drawn to scale and are intended merely for illustrative purposes.

### DETAILED DESCRIPTION

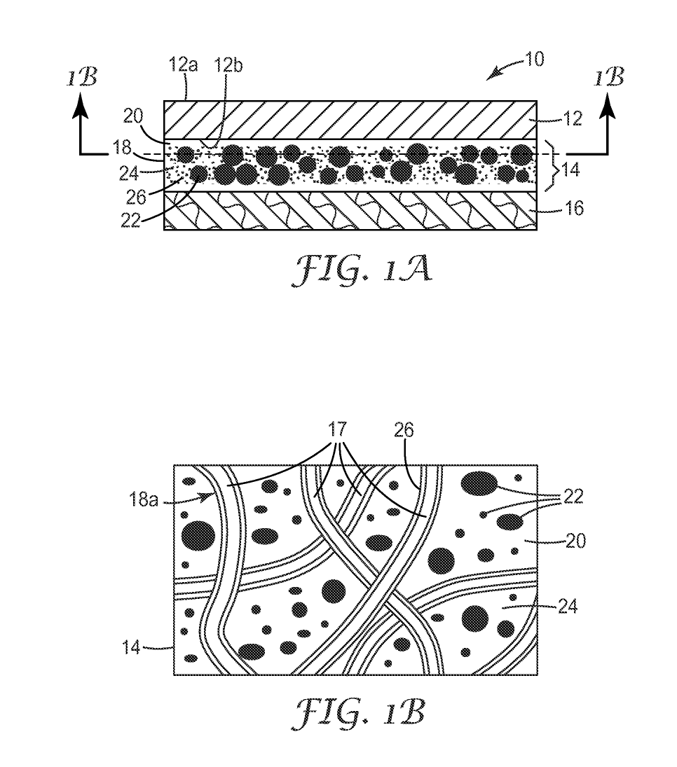

The electrically conductive, single-sided tape of the present disclosure includes a conductive adhesive layer, which includes a first conductive porous substrate having a plurality of passageways and an adhesive material positioned within at least a portion of the passageways, and a second conductive porous substrate. FIG. 1A shows a cross-sectional view of a first embodiment of an electrically conductive, single-sided tape 10 including a second conductive porous substrate 12 and a conductive adhesive layer 14 on a release liner 16. Although a release liner is depicted in FIG. 1A, the electrically conductive, single-sided tape does not need to include a release liner. The conductive adhesive layer 14 includes a first conductive porous substrate 18 and an adhesive material 20 positioned within pores or passageways 24 of the conductive porous substrate 18. The conductive adhesive layer 14 is positioned between the second conductive porous substrate 12 and the release liner 16. Metal particles 22 may optionally be dispersed within the adhesive material 20. The electrically conductive, single-sided tape 10 of the present invention provides an adhesive layer that approaches volume-conductivity, results in reliable and excellent electrical performance for small size contacts and allows for good workability with less curling and/or wrinkling during tape assembly. The single sided tape of the present invention can provide reliable electrical conductance (low electrical resistance) to contact areas that are small, e.g. contact areas that are less than about 10 mm², less than about 5 mm², less than about 1 mm² even less than about 0.2 mm². Additionally, in some embodiments, the electrically conductive, single-sided tape exhibits x-y-z-axis conductivity. The magnitude of the conductivity in the x, y, and z axis may be the same or different.

The second conductive porous substrate 12 provides good electrical performance and handling. In some embodiments, second conductive porous substrate 12 exhibits x-y-z-axis conductivity. The magnitude of the conductivity in the x, y, and z axes may be the same or different. Second conductive porous substrate 12 includes first major surface 12a, second major surface 12b and also contains a plurality of pores or passageways (not shown). Use of the term “passageways” throughout the specification will refer to pores or passageways. Any porous substrate having passageways and capable of being made conductive, e.g. through metallization of a non-conductive material, may be used as the second conductive porous substrate 12. Examples of suitable non-conductive porous substrates which may be made conductive include, but are not limited to: woven or nonwoven fabrics, porous membranes and foams. The woven or nonwoven fabrics, porous membranes and foams are typically formed from polymeric materials including, but not limited to: polyester, e.g. polyethylene terephthalate (PET), nylon, polyurethane, vinylon, polyvinyl acetate (PVA), acrylic and cellulosic polymer, e.g. rayon.

Metallization can be conducted by any known methods including, but not limited to, electroless plating methods, sputtering and vapor deposition techniques. Metallization provides a continuous or semi-continuous electrically conductive path in the original non-conductive material. The metal used for metallization is not particularly limited and includes, but is not limited to, copper, nickel, silver, gold, tin, cobalt, chromium, aluminum and combinations thereof. Metallization may include multiple layers of the same or different metals, e.g. nickel-copper-nickel. An example of a commercially available conductive, nonwoven includes a 28 micron thick, polyester, nonwoven scrim coated with multiple, thin layers of metal, nickel/copper/nickel, available under the trade designation PNW-30-PCN from Ajin-Electron Co., Ltd., Busan, South Korea. Another example of a suitable material for the second conductive porous substrate 12 is a metalized nickel/copper/nickel fabric with an opaque coating applied to the top surface designated as BF30 from Truss Adhesion Technology, Ltd, Incheon Kyounggi, South Korea. Another example of a commercially available conductive, woven fabric includes a 28 micron thick, polyester woven scrim coated with multiple, thin layers of metal, nickel/copper/nickel, available under the trade designation IHD-10C, from Ilhueng EMT Co. Ltd. Buk-gu, Daegu, South Korea. A metal or carbon fiber based woven or non-woven material may also be employed as the second conductive porous substrate 12 including, for example, a conductive mesh available under the trade designation SUI-2790YCL from Seiren, Osaka, Japan. The metal fiber may include multiple layers of different metals. The carbon fiber may also me metalized. In some embodiments, the second conductive porous substrate 12 is between about 5 and about 100 μm thick, particularly between about 10 and about 80 μm thick and more particularly between about 20 and about 50 μm thick.

In some embodiments, the second conductive porous substrate includes a conductive woven or non-woven fabric having conductive fibers. The conductive fibers include electrical contact regions at their surface and interstitial regions between the fibers. The electrical contact regions are, generally, the regions of the fibers in close proximity, i.e. coincident, to the first and second major surfaces 12a and 12b. The electrical contact regions may make electrical communication with a substrate contacting said electrical contact regions, particularly a substrate that is electrically conductive. An optional opaque coating may be disposed in at least a portion of the interstitial regions between the fibers. The opaque coating may be non-electrically conductive. In some embodiments, the electrically conductive, single-sided tape, which includes a conductive woven or nonwoven substrate as the second conductive porous substrate, exhibits x-y-z-axis conductivity. The magnitude of the conductivity in the x, y, and z axes may be the same or different. In yet another embodiment, the majority of the opaque coating is adjacent the first major surface 12a of the second conductive porous substrate.

In another embodiment, a portion of the electrical contact regions are substantially free of the opaque coating. In some embodiments greater than 30%, greater than 50%, greater than 70% or even greater than 90% of the electrical contact regions coincident with the first major surface of the second conductive porous substrate, based on the total area of the electrical contact regions coincident with the first major surface, are substantially free of the opaque coating. By substantially free, it is meant that the contact region has no coating on it or the coating is of minimal thickness that it causes no substantial change in the z-axis electrical resistance of the electrically conductive, single sided-tape. A substantial change in the z-axis resistance would be an increase in the electrical resistance of greater than about 100% greater than about 300% or even greater than about 500%, based on an initial resistance (i.e. the resistance measured when no coating is present) of less than or equal to about 1 ohm.

The conductive adhesive layer 14 provides good electrical performance and handling. The conductive adhesive layer 14 includes a first conductive porous substrate 18 and an adhesive material 20 positioned within pores or passageways 24 of the conductive porous substrate 18.

Any porous substrate having passageways and capable of being made conductive, e.g. through metallization of a non-conductive material, may be used as the first conductive porous substrate 18. Examples of suitable non-conductive porous substrates which may be made conductive include, but are not limited to: woven or nonwoven fabrics, porous membranes and foams. The woven or nonwoven fabrics, porous membranes and foams are typically formed from polymeric materials including, but not limited to: polyester, e.g. polyethylene terephthalate (PET), nylon, polyurethane, vinylon, polyvinyl acetate (PVA), acrylic and cellulosic polymer, e.g. rayon. Metallization can be conducted by any known methods including, but not limited to, electroless plating methods, sputtering and vapor deposition techniques. Metallization provides a continuous or semi-continuous electrically conductive path in the original non-conductive material. The metal used for metallization is not particularly limited and include, but is not limited to, copper, nickel, silver, gold, tin, cobalt, chromium, aluminum and combinations thereof. Metalization may include multiple layers of the same or different metals, e.g. nickel-copper-nickel. An example of a commercially available conductive, nonwoven includes a 28 micron thick, polyester, nonwoven scrim coated with multiple, thin layers of metal, nickel/copper/nickel, available under the trade designation PNW-30-PCN from Ajin-Electron Co., Ltd., Busan, Korea. Another example of a commercially available conductive, woven fabric includes a 28 micron thick, polyester woven scrim coated with multiple, thin layers of metal, nickel/copper/nickel, available under the trade designation IHD-10C, from Ilhueng EMT Co. Ltd. Buk-gu, Daegu, South Korea. A metal or carbon fiber based woven or non-woven material may also be employed as the first conductive porous substrate 18 including, for example, a conductive mesh available under the trade designation SUI-2790YCL from Seiren, Osaka, Japan. The metal fiber may include multiple layers of different metals. The carbon fiber may also me metalized. In some embodiments, the first conductive porous substrate 18 is between about 5 and about 100 μm thick, particularly between about 10 and about 80 μm thick and more particularly between about 20 and about 50 μm thick.

Although not wishing to be bound by theory, it is believed that the conductive fibers of the conductive adhesive layer 14 at the surfaces of the conductive adhesive layer 14 increase the conductive tape contact area efficiency, i.e. increasing the number of an electrical contact regions in electrical communication with a substrate attached thereto, and increase the statistical probability of making successful electrical communication to the second conductive porous substrate 12 or an opposed mated substrate in, for example, an assembly. For an electrically conductive woven or nonwoven fabric, an electrical contact region is a region of one or more conductive fibers that can make electrical communication with another electrically conductive substrate or material. When the second conductive porous substrate 12 is a conductive woven or nonwoven fabric that includes conductive fibers, it is believed that the conductive fibers at the surface of the woven or nonwoven fabric of second conductive porous substrate 12 and the conductive fibers at the surface of conductive adhesive layer 14, that are at the interface between the two components, may also increase the contact area efficiency, i.e. increasing the number of electrical contact regions in electrical communication between second conductive porous substrate 12 and conductive adhesive layer 14, thereby increasing the statistical probability of making successful electrical communication between these two components of the electrically conductive, single-side tape. In so doing, improved electrical conductance, i.e. lower electrical resistance, between the two components as well as improved electrical conductance of the electrically conductive, single-side tape, as a whole, may be achieved. This is particularly useful in applications where two pieces of the single-sided tape are adjoined in an overlap construction, as shown in FIG. 5.

FIG. 1B shows a schematic top plan view of the conductive adhesive layer 14, wherein the first conductive porous substrate 18 (FIG. 1A) of the conductive adhesive layer 14 includes a conductive nonwoven substrate 18a, which is formed by a non-conductive nonwoven web 17 (illustrated as a plurality of fibers 17) that has been coated with a conductive coating 26. The conductive coating can be disposed on the surface of fibers and in some embodiments, penetrate into the fiber. Adhesive material 20 containing optional metal particles 22 is disposed in the passageways or pores 24 of the conductive nonwoven substrate 18a. If open cell foam is used as the first conductive porous substrate 18, the cell walls of the foam and/or exterior surfaces may be metalized.

In some embodiments, the first conductive porous substrate 18 includes conductive fibers, e.g. woven or nonwoven fabrics that include conductive fibers. In these embodiments, a portion of the conductive fibers may protrude above at least one major surface of the conductive adhesive layer 14, to facilitate electrical conduction through the thickness of the tape. The protruding fibers can make electrical contact with, for example, the second conductive porous substrate 12, thus facilitating z-axis conductivity. As discussed herein, the direction substantially perpendicular to at least one major surface of the tape, i.e. through the thickness of the single sided tape, is referred to as the z-axis direction. Two arbitrary orthogonal directions in a plane substantially parallel to at least one major surface of the single sided tape is referred to as the x-y-axis direction. In some embodiments, the x-axis direction corresponds to the length of the tape and the y-axis direction corresponds to the width of the tape. In some embodiments, a portion of the conductive fibers may protrude above both major surfaces of the conductive adhesive layer 14, facilitating electrical conduction between any substrate the tape is attached to (via the lower surface of the conductive adhesive layer 14) through to the top surface of the second conductive porous substrate 12. Having protruding fibers is not required to obtain acceptable z-axis conductivity. However, it is believed that having protruding fibers enhances the electrical connection and improves z-axis conductivity. In some embodiments, conductive adhesive layer 14 exhibits x-y-z-axis conductivity. The magnitude of the conductivity in the x, y, and z axis may be the same or different. In one embodiment, the first conductive nonwoven substrate 18a includes a conductive coating of copper and a corrosion resistant layer of nickel, silver or tin. One suitable example of a conductive woven or nonwoven substrate is Ni/Cu/Ni/PET.

The adhesive material 20 fills at least a portion of the passageways 24 of the first conductive porous substrate 18, resulting in improved cohesion in the conductive adhesive layer 14. In one embodiment, the adhesive material 20 substantially fills the entirety of the passageways. However, due to small bubbles that may become trapped in the first conductive porous substrate 18 during fabrication, the adhesive material 20 may not fill 100% of the volume of the passageways, creating voids in the first conductive porous substrate 18. In one embodiment, the passageways are filled with the adhesive material 20 such that the first conductive porous substrate 18 includes less than about 10% voids, particularly less than about 5% voids, and more particularly less than about 2% voids by volume, based on total volume of the passageways in the first conductive porous substrate 18.

Various manufacturing methods can be employed to form the conductive adhesive layer 14 including, but not limited to: lamination of a transfer adhesive to one or both sides of the appropriate first conductive porous substrate 18; imbibing an adhesive solution, i.e. an adhesive contained in solvent, into at least some of the pores/passageways of the first conductive porous substrate 18 followed by solvent removal and optional curing; or imbibing a substantially 100% solids adhesive precursor solution, comprising monomers, oligomers and/or dissolved polymers, into the pores/passageways of the first conductive porous substrate 18 followed by curing of the adhesive precursor solution to form an adhesive. The imbibing method, i.e. allowing a liquid to flow into at least some of the pores/passageways of the first conductive porous substrate 18, can be accomplished by any known methods including dip coating, spray coating, knife coating, notch bar coating, roll coating and the like.

The method used to fabricate the conductive adhesive layer 14 can affect the resulting structure of the conductive adhesive layer 14. When using a lamination technique to laminate a transfer adhesive to the first conductive porous substrate 18, the adhesive material 20 may be in the passageways 24 at or near the surface of one or both sides of the first conductive porous substrate 18. The depth of penetration of the adhesive material 20 into the pores/passageways 24 of the first conductive porous substrate 18 is dependent on the pressure applied during lamination, the flow properties of the transfer adhesive and properties of the first conductive porous substrate 18 such as, for example, the pore size and thickness of the first conductive porous substrate 18. To facilitate penetration of the adhesive into the first conductive porous substrate 18, the conductive porous substrate/adhesive laminate may be annealed at elevated temperatures. In one embodiment, the first conductive porous substrate 18/adhesive laminate is annealed at between about 30° C. and about 100° C. Under appropriate conditions, the adhesive material 20 may be able to penetrate the entire depth of the first conductive porous substrate 18. In another embodiment, when using an imbibing method, adhesive material 20 may at least partially fill at least some of the pores/passageways 24 of the first conductive porous substrate 18. Thus, depending on the method used to fabricate the conductive adhesive layer 14, adhesive material 20 may penetrate the entire thickness of the first conductive porous substrate 18 as well as be deposited as a layer on the surfaces of the first conductive porous substrate 18 adjacent to conductive polymeric layer 12 and release liner 16, as shown in FIGS. 1A, 1B, 2A, 2B and 3. In some embodiments, the adhesive material 20 may not penetrate the entire depth of the first conductive porous substrate 18 and/or may not extend outside the surfaces of the first conductive porous substrate 18.

In some embodiments, the adhesive material 20 is non-conductive and z-axis conductivity may be obtained via the first conductive porous substrate 18. In this embodiment, electrical connection may be enhanced if the first conductive porous substrate 18 includes conductive fibers that protrude above one or both major surfaces of the conductive adhesive layer 14. Also, during the end use application, appropriate pressure may be applied to the tape, regardless of whether or not the adhesive material 20 is conductive or non-conductive, enhancing electrical connection between the first conductive porous substrate 18 and the second conductive porous substrate 12 and/or enhancing electrical connection between the first conductive porous substrate 18 and any substrate the tape is attached to (via the lower surface of the conductive adhesive layer 14).

In one embodiment, the adhesive material 20 is a pressure sensitive adhesive (PSA) material. To achieve PSA characteristics, the polymer(s) used for the adhesive can be tailored to have a resultant glass transition temperature (Tg) of less than about 0° C. Examples of suitable PSA materials include, but are not limited to: rubber-based PSAs, silicone based PSAs and acrylic based PSAs. Particularly suitable pressure sensitive adhesive are (meth)acrylate copolymers. Such copolymers typically are derived from monomers comprising about 40% by weight to about 98% by weight, often at least about 70% by weight, or at least about 85% by weight, or even at least about 90% by weight, of at least one alkyl (meth)acrylate monomer that, as a homopolymer, has a Tg of less than about 0° C.

Examples of such alkyl (meth)acrylate monomers are those in which the alkyl groups comprise from about 4 carbon atoms to about 14 carbon atoms and include, but are not limited to, n-butyl acrylate, 2-ethylhexyl acrylate, isooctyl acrylate, isononyl acrylate, isodecyl acrylate, and mixtures thereof. Optionally, other vinyl monomers and alkyl (meth)acrylate monomers which, as homopolymers, have a Tg greater than 0° C., such as methyl acrylate, methyl methacrylate, isobornyl acrylate, vinyl acetate, styrene, and the like, may be utilized in conjunction with one or more of the low Tg alkyl (meth)acrylate monomers and copolymerizable polar monomers, including, but not limited to, basic and/or acidic monomers, provided that the Tg of the resultant (meth)acrylate copolymer is less than about 0° C.

The PSA may include from about 3% by weight to about 35% by weight of a hydrophilic, hydroxyl functional monomeric compound, based upon the total weight of monomers comprising the PSA. The hydrophilic, hydroxyl functional monomeric compound may have a hydroxyl equivalent weight of less than 400. The hydroxyl equivalent molecular weight is defined as the molecular weight of the monomeric compound divided by the number of hydroxyl groups in the monomeric compound. Useful monomers include 2-hydroxyethyl acrylate and methacrylate, 3-hydroxypropyl acrylate and methacrylate, 4-hydroxybutyl acrylate and methacrylate, 2-hydroxyethylacrylamide, and N-hydroxypropylacrylamide. Additionally, hydroxy functional monomers based on glycols derived from ethylenoxide or propyleneoxide can also be used. An example of this type of monomer includes a hydroxyl terminated polypropylene glycol acrylate, available as BISOMER PPA 6 from Cognis, Germany. Diols and triols are also contemplated for the hydrophilic monomeric compound. They may also have a hydroxyl equivalent weights of less than 400.

In some embodiments, the PSA may include one or more polar monomers, such as a copolymerizable polar monomer. The polar monomer may be basic or acidic. Basic monomers that may be incorporated into the PSA may comprise from about 2% by weight to about 50% by weight, or about 5% by weight to about 30% by weight, based upon the total weight of monomers comprising the PSA. Exemplary basic monomers include, but are not limited to, N,N-dimethylaminopropyl methacrylamide (DMAPMAm); N,N-diethylaminopropyl methacrylamide (DEAPMAm); N,N-dimethylaminoethyl acrylate (DMAEA); N,N-diethylaminoethyl acrylate (DEAEA); N,N-dimethylaminopropyl acrylate (DMAPA); N,N-diethylaminopropyl acrylate (DEAPA); N,N-dimethylaminoethyl methacrylate (DMAEMA); N,N-diethylaminoethyl methacrylate (DEAEMA); N,N-dimethylaminoethyl acrylamide (DMAEAm); N,N-dimethylaminoethyl methacrylamide (DMAEMAm); N,N-diethylaminoethyl acrylamide (DEAEAm); N,N-diethylaminoethyl methacrylamide (DEAEMAm); N,N-dimethylaminoethyl vinyl ether (DMAEVE); N,N-diethylaminoethyl vinyl ether (DEAEVE); and mixtures thereof. Other useful basic monomers include vinylpyridine, vinylimidazole, tertiary amino-functionalized styrene (e.g., 4-(N,N-dimethylamino)-styrene (DMAS), 4-(N,N-diethylamino)-styrene (DEAS)), N-vinylpyrrolidone, N-vinylcaprolactam, acrylonitrile, N-vinylformamide, (meth)acrylamide, and mixtures thereof.

Acidic monomers that may be incorporated into the PSA may comprise from about 2% by weight to about 30% by weight of the PSA, or about 2% by weight to about 15% by weight, based upon the total weight of monomers comprising the PSA. Useful acidic monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, beta-carboxyethyl acrylate, 2-sulfoethyl methacrylate, styrenesulfonic acid, 2-acrylamido-2-methylpropanesulfonic acid, vinylphosphonic acid, and the like, and mixtures thereof. Due to their availability, typically ethylenically unsaturated carboxylic acids are used.

The adhesive material 20 may be made in-situ during the manufacture of the electrically conductive, single-sided tape or it can be previously made and be in the form, for example, of a polymeric solution, which includes an appropriate solvent for the adhesive material 20. One useful polymeric solution is an acrylic copolymer solution, 59% solids, available under the trade designation SEN-7000 from Geomyung Corp., Cheon-an, Korea.

The pressure sensitive adhesive can be inherently tacky. If desired, tackifiers can be added to the PSA or the adhesive precursor solution before formation of the pressure sensitive adhesive. In one embodiment, the PSA or adhesive precursor solution includes up to about 30% tackifier, or up to about 50% tackifier by weight. Useful tackifiers include, for example, rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins can be used.

Other materials can be added for special purposes, including, for example, fillers, oils, plasticizers, antioxidants, UV stabilizers, pigments, curing agents and polymer additives. Exemplary fillers include, but are not limited to: a heat conductive filler, a flame resistant filler, an anti-static agent, a foaming agent, polymeric microspheres and viscosity modifiers, including fumed silica, such as AEROSIL R 972 from Evonik Industries, Essen, Germany.

The adhesive material 20 may have additional components added to the adhesive precursor solution. For example, the mixture may include a multifunctional crosslinker. Such crosslinkers include thermal crosslinkers which are activated during the drying step of preparing solvent coated adhesives and crosslinkers that copolymerize during the polymerization step. Such thermal crosslinkers may include multifunctional isocyanates, aziridines, multifunctional (meth)acrylates, and epoxy compounds. Exemplary crosslinkers include, but are not limited to, difunctional acrylates such as 1,6-hexanediol diacrylate or multifunctional acrylates such as are known to those of skill in the art. Useful isocyanate crosslinkers include, for example, an aromatic diisocyanate available as DESMODUR L-75 from Bayer, Cologne, Germany and GT75 from Geomyung Corporation, Cheon-an, Korea. Ultraviolet, or “UV”, activated crosslinkers can also be used to crosslink the pressure sensitive adhesive. Such UV crosslinkers may include benzophenones and 4-acryloxybenzophenones. Typically, the crosslinker, if present, is added to the adhesive precursor solutions in an amount of from about 0.05 parts by weight to about 5.00 parts by weight, based upon the total weight of monomers comprising the PSA.

In addition, the adhesive precursor solutions for the provided adhesive materials can include a thermal or a photoinitiator. Examples of thermal initiators include peroxides such as benzoyl peroxide and its derivatives or azo compounds such as VAZO 67, available from E. I. du Pont de Nemours and Co. Wilmington, Del., which is 2,2′-azobis-(2-methylbutyronitrile), or V-601, available from Wako Specialty Chemicals, Richmond, Va., which is dimethyl-2,2′-azobisisobutyrate. A variety of peroxide or azo compounds are available that can be used to initiate thermal polymerization at a wide variety of temperatures. The adhesive precursor solutions can include a photoinitiator. Particularly useful are initiators such as IRGACURE 651, available from BASF Corporation, Florham Park, N.J., which is 2,2-dimethoxy-2-phenylacetophenone. The initiators are typically added to the adhesive precursor solutions in the amount of from about 0.05 parts by weight to about 2 parts by weight, based upon the total weight of monomers comprising the PSA.

In other embodiments, the adhesive material 20 may be a thermosetting adhesive material. More specifically, an adhesive material that can be B-staged (a B-stageable material) may be used. Ultraviolet (UV) B-staging is preferred. In this approach, a dual cure adhesive composition is employed. The first cure is initiated by UV or another light source which initiates a curing reaction to thicken the composition prior to final curing. The final curing may be conducted using a thermal curing system. The adhesive composition contains UV curable monomers and/or oligomers which are mixed with thermally curable monomers and or oligomers. In addition, the corresponding initiators and/or curing agents for both curing mechanisms will be added to the adhesive mixture. After thorough mixing, the adhesive composition is coated on at least one release liner and may be coated between two release liners. During this coating process, a conductive non-woven may be simultaneously embedded in the adhesive coating. The coated composition is then exposed to UV radiation to at least partially cure the UV curable components of the composition. At this stage, the composition may still have a sufficient amount of tack to enable it to be a pressure sensitive adhesive.

The UV curable monomomers and initiators may be those previously described herein. The thermosetting monomers and/or oligomers of the adhesive composition may be epoxy and phenoxy based materials. Other thermosetting resins include urethane and phenolic based materials. In addition, one or more appropriate crosslinkers, curatives and/or accelerators may be added to the adhesive composition. For example, for an epoxy, a crosslinkers such as a dicyandiamide may be used. A preferred dicyandiamide is available under the trade designation Dicyanex 1400B from Air Products and Chemicals, Inc., Allentown, Pa. Accelerators may also be added, a preferred accelerator for an epoxy being a urea-based accelerator, e.g. a urea based accellerator available under the trade designation Amicure UR from Air Products and Chemicals, Inc.

The adhesive material 20 may be a conductive adhesive material. In one embodiment, the adhesive material 20 includes metal particles 22. The metal particles 22 are dispersed in the adhesive material 20, which is then embedded into the first conductive porous substrate 18. Examples of suitable metal particles include, but are not limited to: nickel, copper, tin, aluminum, silver, gold, silver coated copper, silver coated nickel, silver coated aluminum, silver coated tin, silver coated gold; nickel coated copper, nickel coated silver; silver coated or nickel coated: graphite, glass, ceramics, plastics, silica, elastomers, and mica. Also, combinations of these materials can be used in the present disclosure as the metal particles. In one embodiment, the metal particles 22 dispersed in the adhesive material 20 include nickel. An example of suitable, commercially available nickel includes, but is not limited to, T123 from Inco, Vale Canada Limited, Toronto, Canada. The shape of the particles is generally spheroid, but flakes and other higher aspect ratio particles may be used. The aspect ratio may be between about 1 and about 50, between about 1 and about 20 or even between about 1 and about 10. In some embodiments, particles having a spheroid shape may have an aspect ratio between about 1 and about 3, between about 1 and about 2 or even between about 1 and about 1.5. In one embodiment, the adhesive material 20 includes between about 1 and about 70% metal particles, particularly between about 2 and about 60% metal particles and more particularly between about 3 and about 50% metal particles by weight. The metal particles have a mean particle size in the range of about 0.5 to 100 microns, particularly from about 1 to 50 microns and more particularly from about 2 to 20 microns.

The second conductive porous substrate 12 may be adhered to the conductive adhesive layer 14 by any means known in the art, including but not limited to, adhesive and mechanical fasteners, provided the required electrical conduction is maintained between the second conductive porous substrate 12 and the conductive adhesive layer 14. One particularly useful method is to laminate second conductive porous substrate 12 directly to the conductive adhesive layer 14 via adhesive material 20. In some embodiments, the single-sided conductive adhesive tape (excluding optional release liner) has a thickness of between about 10 and about 200 μm, particularly between about 20 and about 160 μm and more particularly between about 40 and about 100 μm.

In another embodiment, a double-sided electrically conductive adhesive tape is formed from the single-sided electrically conductive tape by including a second adhesive material that fills at least a portion of the passageways of the second conductive porous substrate 12. The materials used and the methods for applying the second adhesive material are the same as those described for adhesive material 20 of conductive adhesive layer 14. The second adhesive material may be the same or different from adhesive material 20.

In some embodiments, the electrical resistance of the electrically conductive single-sided tape in the x-y-axis is less than about 10 ohm, less than about 8 ohm, less than about 6 ohm less than about 4 ohm, less than about 2 ohm, less than about 1 ohm, less than about 0.50 ohm and even less about 0.25 ohm; and greater than about 0 ohm, greater than about 0.001 ohm greater than about 0.01 ohm and even greater than about 0.05 ohm. In some embodiments, the electrical resistance of the electrically conductive single-sided tape in the x-y-axis is less than about 10 ohm, less than about 8 ohm, less than about 6 ohm less than about 4 ohm, less than about 2 ohm, less than about 1 ohm and even less about 0.5 ohm; and greater than about 0 ohm, greater than about 0.001 ohm, greater than about 0.01 ohm and even greater than about 0.1 ohm when measured on small contact regions, particularly when the contact region is less than about 1 mm². In some embodiments, the electrical resistance of the electrically conductive single-sided tape in the z-axis is less than about 5 ohm, less than about 3 ohm, less than about 1 ohm less than about 0.5 ohm and even less about 0.2 ohm; and greater than about 0 ohm, greater than about 0.001 ohm greater than about 0.01 ohm and even greater than about 0.05 ohm.

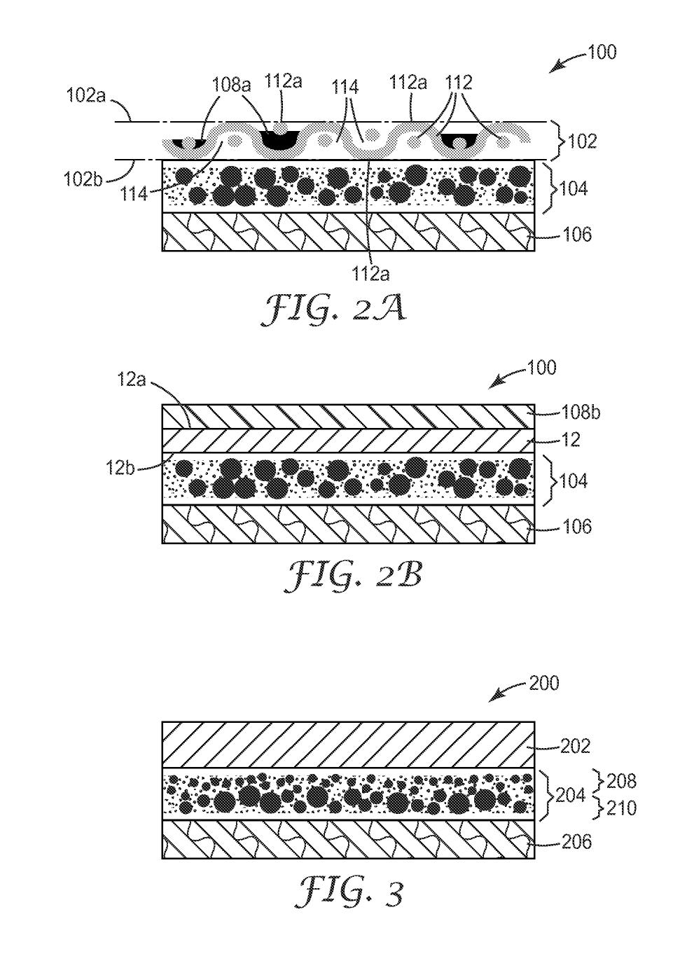

FIG. 2a shows a cross-sectional view of a second embodiment of an electrically conductive, single-sided tape 100 including a second conductive porous substrate 102 and a conductive adhesive layer 104 on an optional release liner 106. The second conductive porous substrate 102 is a conductive woven fabric, although a conductive nonwoven fabric may also be employed, and includes conductive fibers 112 having electrical contact regions 112a and interstitial regions 114 between the fibers. In the figure, a fiber that is represented by a circle indicates a fiber going into the page. The second conductive porous substrate 102 has a first major surface and a second major surface depicted by dashed lines 102a and 102b, respectively. In FIG. 2a, first major surface 102a is depicted by a straight line. However, as electrically conductive, single-sided tape 100 may be flexible, it may be configured to conform to surfaces that may include a variety of shapes including curved shapes. Thus, first major surface 102a and electrically conductive, single-sided tape 100, as a whole, may be curved in shape. The electrical contact regions 112a are, generally, the regions of the fibers in close proximity, i.e. coincident, to the first and second major surfaces 102a and 102b. The electrical contact regions 112a may make electrical communication with a substrate contacting said electrical contact regions, particularly a substrate that is electrically conductive. An optional opaque coating 108a is disposed in at least a portion of the interstitial regions 114 between the fibers 112. In FIG. 2a, a portion of the interstitial regions 114 adjacent first major surface 102a of conductive porous substrate 102 is depicted as including the opaque coating 108a. However, the opaque coating 108a, disposed in at least a portion of the interstitial regions 114 between the fibers 112, may be adjacent the first major surface 102a, the second major surface 102b or both major surfaces 102a and 102b of the second conductive porous substrate 102. In some embodiments, greater than about 50%, greater than about 60%, greater than about 70% greater than about 80%, greater than about 90% and even greater than about 95% of the opaque coating 108a is in the interstitial regions 114 adjacent the first major surface 102a of the second conductive porous substrate 102. These values may be based on the weight of the opaque coating 108a or the volume of the opaque coating 108a. In some embodiments, the interstitial regions 114 between the fibers 112 adjacent the first major surface 102a are coated with opaque coating 108a so as to provide a visually uniform coating on second conductive porous substrate 102.

The second conductive porous substrate 102 functions to increase the tensile strength and improve the handling characteristics of the electrically conductive, single-sided tape 100, improve electrical communication to substrates, particularly substrates having small electrical contact regions, and to protect the conductive adhesive layer 104 from physical damage, dust and debris. When the second conductive porous substrate 102 includes a non-conductive material that has been made conductive by forming a conductive coating on its surface, the conductive coating can be the same as that described for the second conductive porous substrate 12 of the first embodiment. In one embodiment, the second conductive porous substrate 102 has a thickness of between about 5 and about 100 μm, particularly between about 10 and about 80 μm and more particularly between about 20 and about 50 μm. When the second conductive porous substrate 102 includes optional opaque coating 108a, one or more colors, that may be different or the same as that of the second conductive porous substrate 102, may be imparted to the electrically conductive, single-sided tape 100, via the coloring of the opaque coating 108a. The color may be used for color matching purposes, i.e. matching the color of another component of the article the single sided tape is attached to or may be used for light blocking, if the electrically conductive, single-sided tape 100 is used, for example, in an electronic display.

The second conductive porous substrate 102 may be adhered to the conductive adhesive layer 104 by any means known in the art, including, but not limited to, adhesive and mechanical fasteners, provided that the required electrical conduction is maintained between the conductive porous substrate 102 and the conductive adhesive layer 104. One particularly useful method is to laminate the second conductive porous substrate 102 directly to the conductive adhesive layer 104 via adhesive material 20. In some embodiments, the electrically conductive, single-sided tape 100 has a thickness of between about 10 and about 200 μm, particularly between about 20 and about 160 μm and more particularly between about 40 and about 100 μm.

The conductive fibers 112 may be fabricated in the form of single conductive fibers or may be composite conductive fibers fabricated from multiple fibers having a smaller diameter that are combined together, e.g. inter-twined, to form a fiber having a larger diameter. The conductive woven or nonwoven fabric, when formed from conductive fibers, inherently has interstitial regions between the fibers. Throughout the specification, when referring to interstitial regions between fibers, included are both the interstitial regions between the fibers forming the conductive woven or nonwoven fabric and, if composite fibers are used, the interstitial regions that are present between the individual fibers making up the composite fibers. If composite conductive fibers are used to form the conductive woven or nonwoven fabric, the individual fibers making-up the conductive composite fibers do not all need to be electrically conductive, so long as the woven or nonwoven fabric formed from the conductive composite fibers has the required electrical conductivity. Similarly, the fibers forming the woven or nonwoven fabric do not all need to be electrically conductive, so long as the woven or nonwoven fabric formed from the fibers has the required electrical conductivity. Also, during the end use application, appropriate pressure may be applied to the single-sided tape, enhancing electrical connection between the second conductive porous substrate 102 and conductive adhesive layer 104 and/or enhancing electrical connection between the second conductive porous substrate 102 and any substrate the tape is in contact with via the first major surface 102a. As the fibers of the conductive woven or nonwoven fabric have some degree of flexibility, application of appropriate pressure when bonding the tape to a substrate may increase the surface area of the electrical contact regions 112a and may also increase the number of the electrical contact regions 112a, adjacent first and second major surfaces 102a and/or 102b, respectively, thus improving electrical conductivity.

In some embodiments, a portion of the conductive fibers may protrude above at least one major surface of the second conductive porous substrate 102, to facilitate electrical conduction through the thickness of the tape. The protruding fibers can make electrical contact with, for example, the conductive adhesive layer 104, thus facilitating z-axis conductivity. In some embodiments, a portion of the conductive fibers may protrude above both major surfaces of the second conductive porous substrate 102, facilitating electrical conduction between any substrate the tape is in contact with (via first major surface 102a of the second conductive porous substrate 102) through to the bottom surface the conductive adhesive layer 104. Having protruding fibers is not required to obtain acceptable z-axis conductivity. However, it is believed that having protruding fibers enhances the electrical connection and improves z-axis conductivity. In some embodiments, the second conductive porous substrate 102 exhibits x-y-z-axis conductivity.

The second conductive porous substrate 102 may optionally include an opaque coating. The opaque coating may include an ink which may contain a pigment, dye, or combinations thereof. The ink may be in the form of a 100% solids coating. The ink coating may include reactive functional groups that may be cured and/or crosslinked by one or more of heat, high energy radiation, actinic radiation, e.g. UV radiation, and e-beam. The ink may be formed into a liquid opaque coating by dispersing and/or dissolving a pigment and/or dye in an appropriate solvent (e.g. water), an organic solvent or combinations thereof, along with an optional binder. The liquid opaque coating may then be coated directly on at least one surface of the second conductive porous substrate 102. When the solvent is removed from the liquid opaque coating, an opaque coating is formed on the surface of the second conductive porous substrate 102.

If a binder is used, it may be further cured or crosslinked by exposure to heat or actinic radiation, e.g. ultraviolet radiation. The liquid opaque coating may be coated onto the second conductive porous substrate by any known method in the art, provided it yields the desired coating thickness on the surface of the second conductive porous substrate. For example, coating may be conducted by roll coating, spraying coating, printing (e.g. ink jet printing, electrostatic printing, electrophotographic printing, screen printing, stencil printing or pad printing), rotor gravure coating, knife coating, curtain coating, metering rod coating (e.g. Meyer bar), flexographic printing and the like. Solvents used in the liquid opaque coating include those typically used in the art, including, but not limited to: water, methanol, ethanol, propanol, heptane, toluene, tetrahydrofuran, methyl ethyl ketone, ethyl acetate and the like. The binder may be a polymeric binder, including, but not limited to: acrylates, epoxies, phenolics, polyesters, polyamides, polyurethanes and the like. Viscosity modifiers and/or particle suspension aids may be used in the liquid opaque coating. Adhesion primers/promoters may also be used in the liquid opaque coating, or coated on the second conductive porous substrate, prior to coating it with the liquid opaque coating. Both approaches can be used in combination.

In some embodiments, when a conductive woven or nonwoven fabric is used as the second conductive porous substrate, a cleaning step may be used, after the liquid opaque coating is applied to the second conductive porous substrate. The cleaning step may be any conventional cleaning step known in the art; e.g. wiping with a cloth, sponge material or squeegee blade or roller, or using high pressure gas; and is used to remove excess liquid opaque coating from the surface of the second conductive porous substrate, facilitating exposure of the electrical contact regions while maintaining the opaque coating in the interstitial regions between the fibers of the conductive woven or nonwoven fabric.

As shown in FIG. 2a, the opaque coating 108a may provide a coating in the interstitial regions 114 of the second conductive porous substrate 102. Electrical contact regions 112a, which are free of the opaque coating, can provide improved electrical conductivity between the second conductive porous substrate 102 and an electrically conductive substrate in contact therewith. The amount of opaque coating 108a present on the second conductive porous substrate 102 may be selected to provide sufficient opaqueness and/or color matching characteristics to meet desired cosmetic requirements while maintaining needed functional requirements. When the second conductive porous substrate 102 includes a conductive woven or non-woven fabric, the thickness of the opaque coating 108a may be such that it partially fills or fills the interstitial regions in the conductive woven or non-woven fabric, without providing a continuous coating, i.e. a continuous coating covering at least a portion of the first and/or second major surfaces of the second conductive porous substrate 102. The thickness of the opaque coating 108a is then no greater than the thickness of the conductive woven or non-woven fabric and can vary according to the thickness of the conductive woven or non-woven fabric. The thickness of the opaque coating 108a may be greater than about 5%, greater than about 10%, greater than about 20% or even greater than about 30%, less than about 100%, less than about 90%, less than about 80% less than about 70%, less than about 50%, less than about 45%, less than 40% less than 35% or even less than 30% of the thickness of the conductive woven or non-woven fabric.

FIG. 2b shows a cross-sectional view of a third embodiment of an electrically conductive, single-sided tape 100 including a second conductive porous substrate 12 and a conductive adhesive layer 104 on an optional release liner 106. The second conductive porous substrate 12 may be any of the second conductive porous substrates previously described. The second conductive porous substrate 12 has a first major surface 12a second major surface 12b. An optional opaque coating 108b is disposed on at least a portion of first major surface 12a. Opaque coating 108b may be fabricated from the materials and techniques previously described. The opaque coating may include an ink which may contain a pigment, dye, or combinations thereof.

In some embodiments, greater than about 50%, greater than about 60%, greater than about 70% greater than about 80% and even greater than about 95% of the surface area of the first major surface 12a is covered with opaque coating 108b. In one embodiment, substantially the entire surface area of the first major surface 12a is covered with opaque coating 108b.

The opaque coating 108b may be an opaque polymeric film. A pigment and/or dye may be dispersed in a polymeric material. The polymeric material may then be fabricated into a thin film, producing an opaque coating in the form of an opaque film. The opaque film may be adhered to the second conductive porous substrate by any known method in the art. The opaque film may be laminated directly to the second conductive porous substrate during either one of their formation, e.g. the opaque film may be extruded directly on to a previously fabricated second conductive porous substrate 12. In these cases, adhesion between the opaque film and the second conductive porous substrate 12 may be acceptable. In other cases, an adhesive, such as a pressure sensitive adhesive, hot melt (including moisture cured hot melt) or thermoset, may be interposed between the opaque film and the second conductive porous substrate to adhere the materials together. Adhesion primers/promoters for the opaque film and/or second conductive porous substrate may also be used.

The thickness of the opaque coating 108b may be selected in conjunction with the thickness of the second conductive porous substrate, based on the desired overall thickness of the electrically conductive, single-sided tape and electrical conductivity considerations, i.e. whether conductivity is required in the x-y-axis or x-y-z-axis. For single-sided tapes requiring only x-y-axis conductivity, the opaque coating may be non conductive and the thickness of the opaque coating is not particularly limited. In some embodiments, the thickness of the opaque coating is greater than about 0.5 micron, greater than about 1 micron, greater than about 5 microns, greater than about 10 microns or even greater than about 20 microns. In some embodiments, the thickness of the opaque coating is less than about 200 microns, less than about 100 microns, less than about 80 microns or even less than about 50 microns. In some embodiments, the opaque coating has a thickness of between about 0.5 micron and about 200 microns.

For single-sided tapes, as described in FIG. 2b, requiring x-y-z-axis conductivity, the thickness of the opaque coating 108b is generally limited, due to z-axis electrical conductivity requirements, unless the opaque coating is electrically conductive. For non-electrically conductive opaque coatings, the thickness of the opaque coating is less than about 3 μm, less than 1 about μm, less than about 0.5 μm and even less than about 0.2 μm. However, depending on the materials used to fabricate the opaque coating, there is a lower limit to the coating thickness, i.e. if the coating thickness is too low, the coating may not have the required level of opaqueness. In one embodiment, the coating thickness may be greater than about 0.020 μm, greater than about 0.035 μm and even greater than about 0.050 μm.

If opaque coating 108b is electrically conductive, the thickness of the opaque coating may not be particularly limited. For electrically conductive, opaque coatings, in some embodiments, the thickness of the opaque coating is greater than about 0.5 micron, greater than about 1 micron, greater than about 5 microns, greater than about 10 microns or even greater than about 20 microns. In some embodiments, the thickness of the opaque coating is less than about 200 microns, less than about 100 microns, less than about 80 microns or even less than about 50 microns. In some embodiments, the opaque coating has a thickness of between about 0.5 micron and about 200 microns. However, due to cost considerations, handling requirements and thickness limitations of the electrically conductive, single-sided tape, which are associated with the end use application(s), it is useful for the opaque coating to be as thin as possible and non-conductive. In this regard, one particularly useful construction is that shown in FIG. 2a, where the opaque coating is predominantly in the interstitial regions 114 between the fibers 112 of the woven or nonwoven, second conductive porous substrate 102 and, optionally, where the opaque coating is non-conductive.

In the embodiments which include an opaque coating, the opaque coating provides color to the second conductive porous substrate. This is particularly beneficial when the opaque coating may be visible in, for example, a display assembly that includes the electrically conductive, single-sided tape of the present disclosure. The pigments and/or dyes used in the opaque coatings, whether they are formed from an opaque coating solution or an opaque polymeric film, are selected based on desired qualities or attributes of the final product assembly. Consequently, inks that produce color in the visible region of the electromagnetic spectrum are typically used, for example: blue, green, yellow, orange, red and purple. Additionally, inks may be used that produce a black or a white colored opaque coating. Fluorescent dyes and pigments may also be used in the inks. A useful opaque ink is one made from a polyurethane resin with carbon black fillers.

Electrically conductive, opaque coatings can be prepared by using an ink which contains electrically conductive pigment, dye, particles or combinations thereof. In some embodiments, the opaque coating 108a and 108b (FIGS. 2a and 2b) include dispersed conductive particles, particularly when the opaque coating is in the form of a polymeric film. Examples of suitable conductive particles include, but are not limited to, particles of metal, graphite and carbon black. Metal particles, include, but are not limited to: nickel, copper, tin, aluminum, silver, gold, silver coated copper, silver coated nickel, silver coated aluminum, silver coated tin, silver coated gold; nickel coated copper, nickel coated silver. In addition, non-conductive particles coated with a conductive layer may also be used. For example, metal coated: graphite, glass, ceramics, plastics, silica, elastomers, and mica. The metal used to coat the non-conductive particles includes, but is not limited to, the metals disclosed above. Also, combinations of these materials can be used in the present disclosure as the conductive particles. The conductive particles may be individual particles, i.e. primary particles, or aggregates of the individual particles that form aggregate particles or filamentary (chain-like) structures. The conductive particles may have a mean primary particle size in the range of about 0.5 to 100 microns, particularly from about 1 to 50 microns and more particularly from about 2 to 20 microns. The shape of the primary particles is generally spheroid, but flakes and other higher aspect ratio particles, e.g. fibers, may be used. The aspect ratio of the primary particles may be between about 1 and about 50, between about 1 and about 20 or even between about 1 and about 10. In some embodiments, the primary particles having a spheroid shape may have an aspect ratio between about 1 and about 3, between 1 and about 2 or even between about 1 and about 1.5. In one embodiment, the conductive particles of conductive polymeric layer 12 include nickel. An example of suitable, commercially available nickel particle includes, but is not limited to, high purity nickel powder with a fine, three dimensional, filamentary structure, available under the trade designation FILAMENTARY NICKLE POWDER TYPE 255 from Novamet Specialty Products Corporation, Wyckoff, N.J.

The amount of conductive particles in the electrically conductive, opaque coating is selected based on particle type, shape and conductivity. The amount of conductive particles needs to be high enough to provide the desired level of conductivity, while being low enough to enable formation of the opaque coating and to yield appropriate handling characteristics of the electrically conductive, single-sided tape. In one embodiment, the electrically conductive, opaque coating includes between about 5 and about 90% conductive particles, particularly between about 15 and about 75% conductive particles and more particularly between about 20 and about 60% conductive particles by weight.

The conductive particles included in the opaque coating may be dispersed in the opaque coating by any known mixing techniques, including melt blending and solvent blending. For example, the conductive particle may be added to a polymeric material by conventional melt mixing via a batch or continuous process, e.g. single screw or twin screw extrusion, followed by the extrusion through an appropriate die to form an opaque coating in the form of a polymeric thin film. The opaque coating can be further processed to add porosity if desired and the material could also be further metalized as previously described.

FIG. 3 shows a cross-sectional view of a fourth embodiment of an electrically conductive, single-sided tape 200 including a second conductive porous substrate 202 and a conductive adhesive layer 204 on an optional release liner 206. The forth embodiment of the electrically conductive, single-sided tape 200 is similar in construction and function to the first embodiment of the conductive, single-sided tape 10 except that the forth embodiment of the conductive, single-sided tape 200 includes a first adhesive layer 208 and a second adhesive layer 210 within conductive adhesive layer 204.

First and second adhesive layers 208 and 210 may include particles. The first and second adhesive layers 208 and 210 may include the same particle types or may include different particle types. In one embodiment, both the first and second adhesive layers 208 and 210 include the same particle type. For example, both the first and second adhesive layers 208 and 210 may include nickel particles. In another embodiment, the first and the second adhesive layers 208 and 210 include different particle types. For example, the first adhesive layer 208 may include nickel particles while the second adhesive layer 210 includes silver particles. In addition, the first and second adhesive layers 208 and 210 may include the same number of particle types or may include a different number of particle types. In one embodiment, both the first and second adhesive layers 208 and 210 include two particle types. In another embodiment, the first adhesive layer 208 includes only one particle type while the second adhesive layer 210 includes more than one particle type. For example, the first adhesive layer 208 may include only nickel particles while the second adhesive layer 210 includes silver and nickel particles. Any combination of particle types may be included in the first and second adhesive layers 208 and 210 without departing from the intended scope of the present invention.

The first and second adhesive layers may include any of the materials described for the adhesive material 20. In one embodiment, both the first and second adhesives layers 208 and 210 are acrylic based. The compositions of the acrylic copolymers of the first and second adhesive layers 208 and 210 may be the same or may be different.

One method of forming the electrically conductive, single-sided tape 10, 100, 200 of the present invention is by using a dual liner coating and UV curing process. The method includes preparing a syrup including an adhesive and a photoinitiator to form a prepolymer, imbibing the prepolymer in pores of a first conductive porous substrate, passing the first conductive porous substrate and prepolymer between a first and second liner, curing the prepolymer to form a conductive adhesive layer, e.g. a first conductive porous substrate embedded pressure sensitive adhesive layer, removing the first liner from the conductive adhesive layer, and laminating the conductive adhesive layer onto a second conductive porous substrate. An optional opaque coating may be disposed on the exposed major surface of the second conductive porous substrate.

Another method of forming the electrically conductive, single-sided tape 10, 100, 200 of the present invention uses a single liner coating and thermal curing process. The method includes coating a polymer adhesive solution, for example an acrylic copolymer solution, onto a first conductive porous substrate by directly imbibing the polymer adhesive solution into the pores or passageways of the first conductive porous substrate, disposing the polymer adhesive solution and the first conductive porous substrate on a liner, drying and heat curing the polymer adhesive solution to form a conductive adhesive layer, e.g. a first conductive porous substrate embedded pressure sensitive adhesive layer, and laminating the conductive adhesive layer on to a second conductive porous substrate. An optional opaque coating may be disposed on the exposed major surface of the second conductive porous substrate.

Another method of forming the conductive, single-sided tape 10, 100, 200 of the present invention includes using a single liner coating, thermal curing and transfer laminating process. The method includes coating a polymer adhesive solution, for examples an acrylic copolymer solution, onto a release liner, drying and heat curing the coated polymer adhesive solution on the liner and transferring the polymer adhesive layer on the liner onto both sides of the first conductive porous substrate to form a conductive adhesive layer, e.g. a first conductive porous substrate embedded pressure sensitive adhesive layer, with the adhesive positioned within at least a portion of the passageways of the conductive porous substrate, and laminating the conductive adhesive layer on to a second conductive porous substrate. An optional opaque coating may be disposed on the exposed major surface of the second conductive porous substrate.

Each method can be combined to form the conductive, single-sided tape 10, 100, 200 of the present invention. For example, in the fourth embodiment of the conductive, single-sided tape 200, the first and second adhesive layers 208 and 210 may be fabricated using the same process, or different processes. In one embodiment, one adhesive layer may be made from a solution coating process on a release liner and then laminated by a transfer process to the first conductive porous substrate. The second adhesive layer may be made by an imbibing process, e.g. coating an adhesive solution directly onto the first conductive porous substrate and then drying and optionally, curing.

In an end-use assembly fabrication process, the method of bonding an electrically conductive single-side tape to a substrate may include providing using a single layer of the electrically-conductive single-sided tape. In one embodiment, the method of bonding includes providing a first substrate having a first surface, providing an electrically conductive single-sided tape according to any of the preceding embodiments, bonding the first surface of the first substrate to the conductive adhesive layer of the electrically conductive single-sided tape. The method of bonding may further include providing a second substrate having a first surface and positioning the first surface of the second substrate such that it is adjacent to and may be in electrical communication with the second conductive porous substrate of the electrically conductive single-sided tape. One or both, i.e. at least one, of the first substrate and second substrate may be electrically conductive. One or both, i.e. at least one, of the first and second substrates may be components of an electronic device. One or both, i.e. at least one, of the first and second components of the electronic device may be electrically conductive.

In another embodiment, as shown in FIG. 7, an assembly 700 includes a first substrate 710, having a first surface 712, and an electrically conductive single-sided tape 720 of any of the preceding embodiments, wherein the first surface 712 of the first substrate 710 is bonded to the conductive adhesive layer 722 of the electrically conductive single-sided tape 720. The assembly 700 may further include a second substrate 730, wherein the second substrate 730 is positioned adjacent to and may be in electrical communication with the second conductive porous substrate 724 of the electrically conductive single-sided tape 720. One or both, i.e. at least one, of the first and second substrates of the assembly may be electrically conductive.

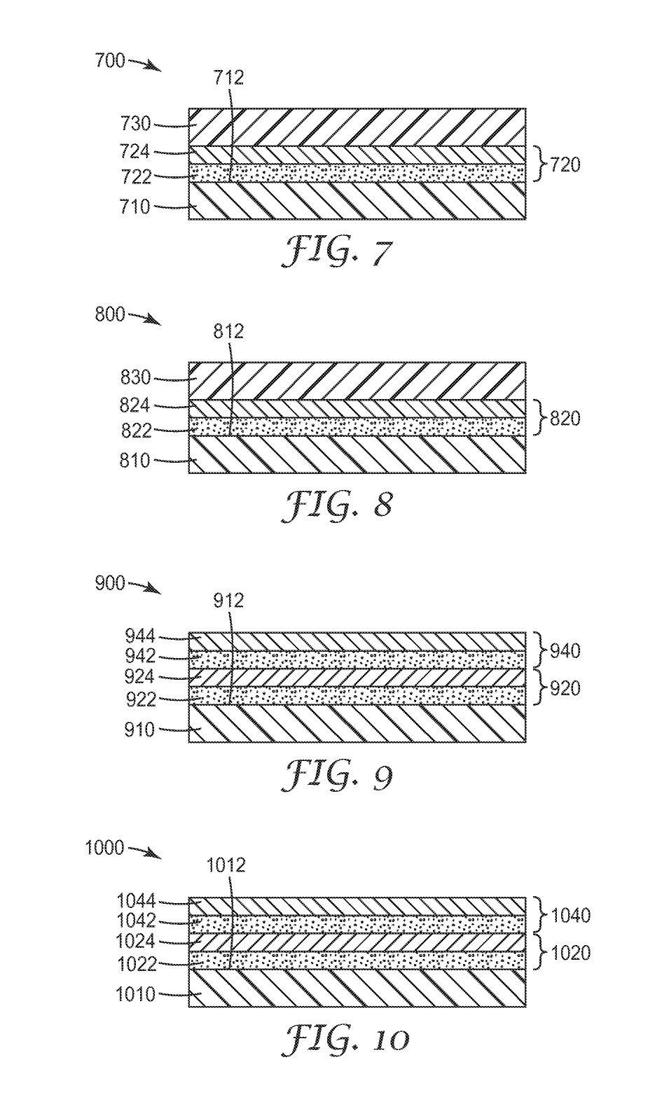

In another embodiment, as shown in FIG. 8, an electronic device assembly 800 includes a first electronic device component 810 having a first surface 812 and an electrically conductive single-sided tape 820 of any of the preceding embodiments, wherein the first surface 812 of the first electronic device component 810 is bonded to the conductive adhesive layer 822 of the electrically conductive single-sided tape 820. The electronic device assembly may further include a second electronic device component 830, wherein the second electronic device component 830 is positioned adjacent to and may be in electrical communication with the second conductive porous substrate 824 of the electrically conductive single-sided tape 820. One or both, i.e. at least one, of the first and second electronic device components may be electrically conductive.

In an end-use assembly fabrication process, the method of bonding an electrically conductive single-side tape to a substrate may include using multiple, adjacent tape layers, e.g. overlapping tape layers from a single tape layer, used for example in an EMI shielding application associated with cable wrapping; or at least two individual tape layers, used for example in a cross-hatch tape configuration in power collection tapes. In one embodiment, the method of bonding includes providing a first substrate having a first surface, providing a first layer of an electrically conductive single-sided tape according to any of the preceding embodiments, bonding the first surface of the first substrate to the conductive adhesive layer of the first layer of electrically conductive single-sided tape, providing a second layer of electrically conductive single-sided tape according to any of the preceding embodiments, bonding the second conductive porous substrate of the first layer of electrically conductive single-sided tape to the conductive adhesive layer of the second layer of electrically conductive single-sided tape. The first substrate may be an electronic device component. The first and second layers of the electrically conductive single-sided tapes may be the same or different.

In another embodiment, as shown in FIG. 9, an assembly 900 includes a first substrate 910 having a first surface 912; a first layer of an electrically conductive single-sided tape 920 of any of the preceding embodiments, wherein the first surface 912 of the first substrate 910 is bonded to the conductive adhesive layer 922 of the first layer of electrically conductive single-sided tape 920; and a second layer of electrically conductive single-sided tape 940 according to any of the preceding embodiments, wherein the second conductive porous substrate 924 of the first layer of electrically conductive single-sided tape 920 is bonded to the conductive adhesive layer 942 of the second layer of electrically conductive single-sided tape 940. The second layer of electrically conductive single-sided tape 940 also includes second conductive porous substrate 944. The first and second layers of the electrically conductive single-sided tapes may be the same or different.

In another embodiment, as shown in FIG. 10, an electronic device assembly 1000 includes a first electronic device component 1010 having a first surface 1012; a first layer of an electrically conductive single-sided tape 1020 of any of the preceding embodiments, wherein the first surface 1012 of the first electronic device component 1010 is bonded to the conductive adhesive layer 1022 of the first layer of electrically conductive single-sided tape 1020; and a second layer of electrically conductive single-sided tape 1040 according to any of the preceding embodiments, wherein the second conductive porous substrate 1024 of the first layer of electrically conductive single-sided tape 1020 is bonded to the conductive adhesive layer 1042 of the second layer of electrically conductive single-sided tape 1040. The second layer of electrically conductive single-sided tape 1040 also includes second conductive porous substrate 1044. The first and second layers of the electrically conductive single-sided tapes may be the same or different.

In end use assembly fabrication processes which require multiple, adjacent tape layers of electrically conductive single-sided tape, non-protruding fibers of the conductive adhesive layer of the first piece of tape will be brought into electrical communication with the second conductive porous substrate of the second piece of tape via the pressure, time and/or temperature (above room temperature) of the fabrication process. In one particular embodiment, the fibers are easily available to contact the bonding substrate using typical assembly fabrication processes, e.g. lamination. End use assembly fabrication conditions may include bonding temperature between about 20° C. to about 150° C., between about 20° C. to about 70° C., between about 20° C. to about 50° C. and even between about 20° C. to about 30° C., bonding pressure between about 0.5 psi to about 50 psi, between about 0.5 psi to about 25 psi, between about 0.5 psi to about 15 psi, and even between about 0.5 to about 10 psi, and bonding time between about 0.5 to about 600 seconds, between about 0.5 to about 100 seconds, between about 0.5 to about 30 seconds, between about 0.5 to about 15 seconds, between about 0.5 to about 10 seconds and even between about 0.5 to about 5 seconds. In embodiments in which the conductive adhesive layer includes a pressure sensitive adhesive, one particular set of bonding conditions include a temperature between about 20° C. to about 30° C., a pressure between about 0.5 to about 10 psi and a bonding time between about 0.5 to about 5 seconds. Under these bonding conditions, conductivity is achieved, surpassing other know conductive tapes applied using similar conditions. The moderate bonding conditions also enable a lower cost assembly process. One of ordinary skill in the art can modify the process conditions to obtain acceptable conductivity, based on the tape application method, e.g. flat bed lamination, rolling lamination, vacuum lamination and the like. The above end use assembly fabrication conditions may also be used in applications employing a single layer of electrically conductive single-sided tape.

Select embodiments of the present disclosure include, but are not limited to, the following:

In a first embodiment, the present disclosure provides an electrically conductive, single-sided tape comprising:

a conductive adhesive layer comprising:
a first conductive porous substrate having a plurality of passageways; and
an adhesive material positioned within at least a portion of the passageways; and

a second conductive porous substrate having first and second major surfaces and a plurality of passageways, wherein the second major surface of the second conductive porous substrate is positioned adjacent the conductive adhesive layer.

In a second embodiment, the present disclosure provides an electrically conductive, single-sided tape according to the first embodiment, wherein the second conductive porous substrate comprises a conductive woven or nonwoven fabric having conductive fibers, wherein the conductive fibers comprise electrical contact regions at their surface and interstitial regions between the fibers.

In a third embodiment, the present disclosure provides an electrically conductive, single-sided tape according to the second embodiment, wherein the electrically conductive, single-sided tape further comprises an opaque coating disposed in at least a portion of the interstitial regions between the fibers.

In a fourth embodiment, the present disclosure provides an electrically conductive, single-sided tape according to the first to third embodiments, wherein the electrical resistance, as measured by Test Method 3, is less than about 8 ohms.

In a fifth embodiment, the present disclosure provides an electrically conductive, single-sided tape according to the third and fourth embodiments, wherein the opaque coating is non-electrically conductive.

In a sixth embodiment, the present disclosure provides an electrically conductive, single-sided tape according to the third to fifth embodiments, wherein the greater than 50% of the opaque coating is in the interstitial regions adjacent the first major surface of the second conductive porous substrate.

In a seventh embodiment, the present disclosure provides an electrically conductive, single-sided tape according to the third to sixth embodiments, wherein a portion of the electrical contact regions are substantially free of the opaque coating.

In an eighth embodiment, the present disclosure provides an electrically conductive, single-sided tape according to the third to seventh embodiments, wherein greater than 30%, of the electrical contact regions coincident with the first major surface, based on the total area of the electrical contact regions adjacent the first major surface, are substantially free of the opaque coating.

In a ninth embodiment, the present disclosure provides an electrically conductive, single-sided tape according to the third to eighth embodiments, wherein the conductive fibers are conductive composite fibers.

In a tenth embodiment, the present disclosure provides an electrically conductive, single-sided tape according to the first embodiment further comprising an opaque coating disposed on at least a portion of first major surface of the second conductive porous substrate

In an eleventh embodiment, the present disclosure provides an electrically conductive, single-sided tape according to the tenth embodiment, wherein the opaque coating is an opaque polymeric film.

In a twelfth embodiment, the present disclosure provides an electrically conductive, single-sided tape according to the first to eleventh embodiments, wherein the adhesive material is a conductive adhesive material.

In a thirteenth embodiment, the present disclosure provides an electrically conductive, single-sided tape according to the first to twelfth embodiments, wherein the conductive adhesive material comprises metal particles.

In a fourteenth embodiment, the present disclosure provides an electrically conductive, single-sided tape according to the first to thirteenth embodiments, wherein the metal particles comprise at least one of: nickel, copper, tin, aluminum, silver, silver coated copper, silver coated nickel, silver coated aluminum, silver coated tin, silver coated gold, silver coated graphite, silver coated glass, silver coated ceramics, silver coated plastics, silver coated silica, silver coated elastomers, silver coated mica, nickel coated copper, nickel coated silver, nickel coated graphite, nickel coated glass, nickel coated ceramics, nickel coated plastics, nickel coated silica, nickel coated elastomers, nickel coated mica, and combinations thereof.

In a fifteenth embodiment, the present disclosure provides an electrically conductive, single-sided tape according to the first to fourteenth embodiments, wherein the first conductive porous substrate is a conductive nonwoven substrate and the second conductive porous substrate is a conductive woven or conductive nonwoven substrate.

In a sixteenth embodiment, the present disclosure provides an electrically conductive, single-sided tape according to the first to fifteenth embodiments, wherein the first conductive porous substrate comprises conductive fibers.

In a seventeenth embodiment, the present disclosure provides an electrically conductive, single-sided tape according to the first to sixteenth embodiments, wherein a portion of the conductive fibers of the first conductive porous substrate protrude from at least one major surface of the conductive adhesive layer.

In an eighteenth embodiment, the present disclosure provides an electrically conductive, single-sided tape according to the first to seventeenth embodiments, wherein a portion of the conductive fibers of the first conductive porous substrate protrude from both major surfaces of the conductive adhesive layer.

In a nineteenth embodiment, the present disclosure provides an electrically conductive, single-sided tape according to the third to eighteenth embodiments, wherein a portion of the conductive fibers of the second porous substrate protrude through the opaque coating.

In a twentieth embodiment, the present disclosure provides an electrically conductive, single-sided tape according to the first to nineteenth embodiments, further comprising a release liner positioned adjacent the conductive adhesive layer.

In a twenty-first embodiment, the present disclosure provides an electrically conductive, single-sided tape according to the first to twentieth embodiments, wherein the conductive single-sided tape is between about 15 um and about 150 μm thick.

In a twenty-second embodiment, the present disclosure provides an electrically conductive, single-sided tape according to the first to twenty-first embodiments, wherein at least one of the first and second conductive porous substrates includes a conductive coating.

In a twenty-third embodiment, the present disclosure provides an electrically conductive, single-sided tape according to the first to twenty-second embodiments, wherein the adhesive material is a pressure sensitive adhesive material.

In a twenty-fourth embodiment, the present disclosure provides an electrically conductive, single-sided tape according to the first to twenty-third embodiments, wherein the adhesive material is an UV or thermally B-stageable adhesive material.

In a twenty-fifth embodiment, the present disclosure provides an electrically conductive, single-sided tape according to the first to twenty-fourth embodiments, wherein the conductive adhesive layer comprises a first adhesive layer and a second adhesive layer.

In a twenty-sixth embodiment, the present disclosure provides an electrically conductive, single-sided tape according to the twenty-fifth embodiment, wherein the first adhesive layer comprises one metal particle type.

In a twenty-seventh embodiment, the present disclosure provides an electrically conductive, single-sided tape according to the twenty-fifth to twenty-sixth embodiments, wherein the second adhesive layer comprises at least two metal particles types.

In a twenty-eighth embodiment, the present disclosure provides an electrically conductive, single-sided tape according to the first to twenty-seventh embodiments, wherein the passageways of the first conductive porous substrate are filled with adhesive material such that the conductive porous substrate includes less than about 10% voids by volume.

In a twenty-ninth embodiment, the present disclosure provides an electrically conductive, single-sided tape according to the first to twenty-eighth embodiments, wherein the passageways of the first conductive porous substrate are filled with adhesive material such that the conductive porous substrate includes less than about 2% voids by volume.

In a thirtieth embodiment, the present disclosure provides an assembly comprising:
a first substrate having a first surface; and
an electrically conductive single-sided tape, according to any of one of embodiments one to twenty-nine, wherein the first surface of the first substrate is bonded to the conductive adhesive layer of the electrically conductive single-sided tape.

In a thirty-first embodiment, the present disclosure provides an assembly according to the thirtieth embodiment further comprising a second substrate, wherein the second substrate is positioned adjacent to and in electrical communication with the second conductive porous substrate of the electrically conductive single-sided tape.

In a thirty-second embodiment, the present disclosure provides an assembly according to the thirty-first embodiment, wherein at least one of the first and second substrates of the assembly are electrically conductive.

In a thirty-third embodiment, the present disclosure provides an assembly comprising:
a first substrate having a first surface;
a first layer of an electrically conductive single-sided tape according to any one of embodiments one to twenty-nine, wherein the first surface of the first substrate is bonded to the conductive adhesive layer of the first layer of electrically conductive single-sided tape; and
a second layer of electrically conductive single-sided tape according to any one of embodiments one to twenty-nine, wherein the second conductive porous substrate of the first layer of electrically conductive single-sided tape is bonded to the conductive adhesive layer of the second layer of electrically conductive single-sided tape.

In a thirty-fourth embodiment, the present disclosure provides an assembly according to the thirty-third embodiment, wherein the first and second layers of the electrically conductive single-sided tapes are different.

In a thirty-fifth embodiment, the present disclosure provides an electronic device assembly comprising:
a first electronic device component having a first surface; and
an electrically conductive single-sided tape according to any one of embodiments one to twenty-nine, wherein the first surface of the first electronic device component is bonded to the conductive adhesive layer of the electrically conductive single-sided tape.

In a thirty-sixth embodiment, the present disclosure provides an electronic device assembly according to the thirty-fifth embodiment, further comprising a second electronic device component, wherein the second electronic device component is positioned adjacent to and in electrical communication with the second conductive porous substrate of the electrically conductive single-sided tape.

In a thirty-seventh embodiment, the present disclosure provides an electronic device assembly according to the thirty-sixth embodiment, wherein at least one of the first and second electronic device components are electrically conductive.

In a thirty-eighth embodiment, the present disclosure provides an electronic device assembly comprising:
a first electronic device component having a first surface;
a first layer of an electrically conductive single-sided tape according to any one of embodiments one to twenty-nine, wherein the first surface of the first electronic device component is bonded to the conductive adhesive layer of the first layer of electrically conductive single-sided tape; and
a second layer of electrically conductive single-sided tape according to any one of embodiments one to twenty-nine, wherein the second conductive porous substrate of the first layer of electrically conductive single-sided tape is bonded to the conductive adhesive layer of the second layer of electrically conductive single-sided tape.

In a thirty-ninth embodiment, the present disclosure provides an electronic device assembly according to the thirty-eighth embodiment, wherein the first and second layers of the electrically conductive single-sided tapes are different.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Test Methods

### Electrical Resistance Test Method 1 (x-y Resistance)

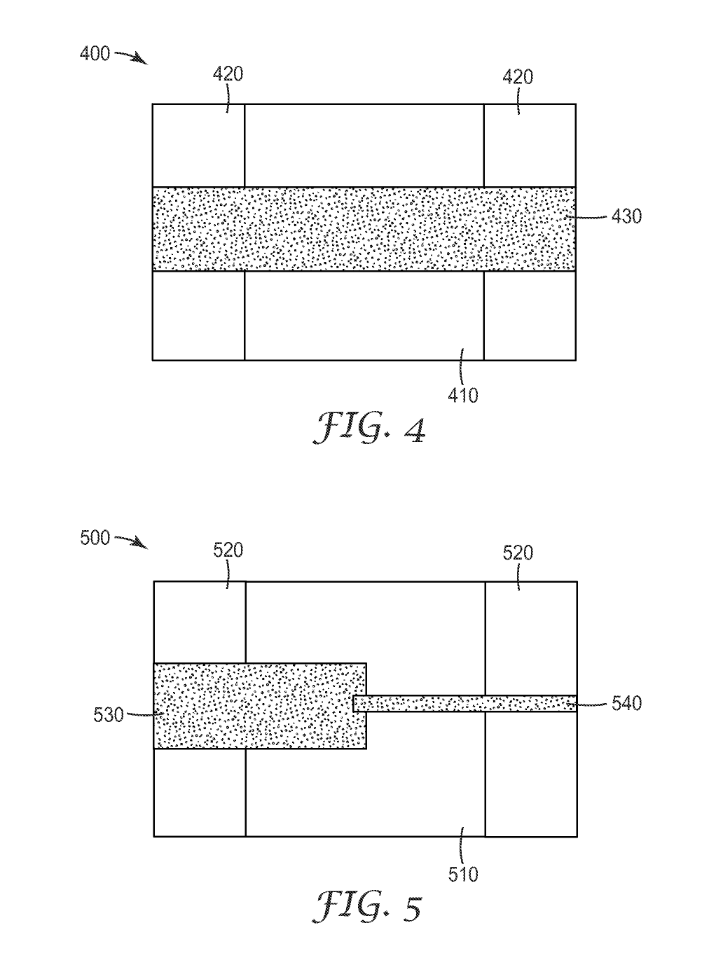

The electrical resistance of an electrically conductive single-sided tape was evaluated by measuring the electrical resistance between two copper foil tape strips that were in electrical communication via the conductive single sided tape. A test panel with Cu foil tapes was prepared as follows. Two strips of copper foil tape, each about 10 mm×30 mm, were laminated to a 50 mm×30 mm polymethymethacrylate plate. The Cu tape strips were applied along each 30 mm edge of the plastic plate. The distance between the two strips of Cu tape was about 30 mm. A piece of conductive single-sided tape, 50 mm×10 mm, with release liner removed, was then hand laminated to the plastic plate. The conductive single-sided tape was applied perpendicular to the Cu tape strips, such that the ends of the conductive single-sided tape overlapped with each of the strips of Cu tape, producing a 10 mm×10 mm region of overlap between each strip of Cu foil tape and the conductive single sided tape. After initial hand lamination, a 2 kg rubber roll was rolled across the conductive single sided tape, producing a test panel, FIG. 4. FIG. 4 shows test panel 400 with plastic plate 410, strips of Cu foil tape 420 applied to its surface and electrically conductive, single-sided tape 430. After 20 minutes of dwell time, the D.C. electrical resistance between the copper foil strips was measured using a Keithley 580 micro-ohmmeter available from Keithley Instruments Inc., Cleveland, Ohio by placing the ohmmeter leads in contact with the exposed surface of the Cu foil tape strips on either side of the plate. The electrical resistance was recorded 30 seconds after the leads of the micro-ohmmeter contacted the Cu foil tape strips of the test panel. Ten test panels were prepared and measured for electrical resistance in this manner. Results are shown in Table 1.

Electrical Resistance Test Method 2 (z-Axis Resistance)

The electrical resistance of an electrically conductive single-sided tape was evaluated by measuring the electrical resistance between two copper foil tape strips that were in electrical communication via the conductive single sided tape. A test panel with Cu foil tapes was prepared similarly to that disclosed in Electrical Resistance Test Method 1, except, two strips of conductive single-sided tape were used. A first strip was about 10 mm×25 mm, a second strip was about 2 mm×27 mm. After removing the release liner, the first strip was laminated to the test panel, perpendicular to the Cu foil tape, making contact with one of the Cu foil tape strips. A 2 kg rubber roll was rolled across the first strip of conductive single sided tape. After removing the release liner, the second strip was laminated to the test panel, perpendicular to the Cu foil tape strips, such that, it made contact with the second Cu foil strip and then overlapped the first strip of the conductive single sided tape. A 2 kg rubber roll was rolled across the second strip of conductive single sided tape, producing a test panel, FIG. 5. FIG. 5 shows test panel 500 with plastic plate 510, strips of Cu foil tape 520 applied to its surface, first electrically conductive, single-sided tape strip 530 and second electrically conductive, single-sided tape strip 540. After 20 minutes of dwell time, the D.C. electrical resistance between the copper foil strips was measured using a Keithley 580 micro-ohmmeter by placing the ohmmeter leads in contact with the exposed surface of the Cu foil tape strips on either side of the plate. The electrical resistance was recorded 30 seconds after the leads of the micro-ohmmeter contacted the Cu foil tape strips of the test panel. Ten test panels were prepared and measured for electrical resistance in this manner. Results are shown in Table 1.

### Electrical Resistance Test Method 3 (x-y Resistance of Small Contact Area Features)

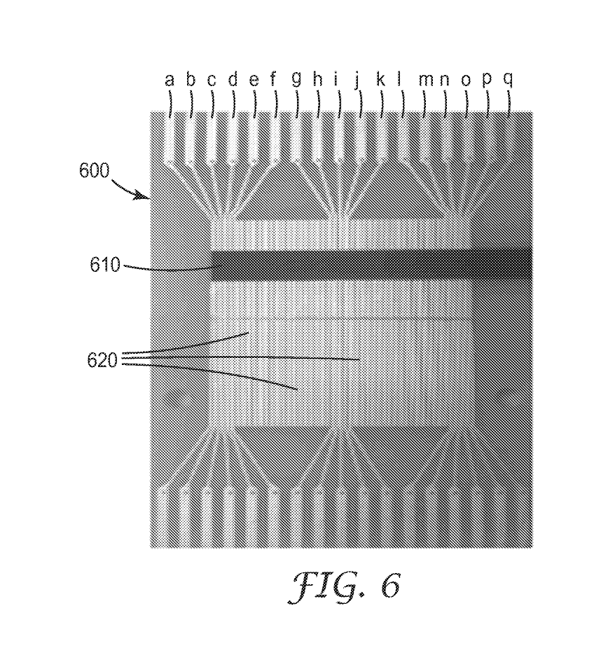

The electrical resistance of an electrically conductive single-sided tape was evaluated by measuring the x-y-axis electrical resistance between two gold plated line traces of a test printed circuit board (PCB). Multiple pairs of traces, 10 pairs, were measured to determine the ability to make electrical contact between small, electrical contact area traces that were in electrical communication via the electrically conductive, single-sided tape. A PCB test panel, 3.0 inch (7.6 cm)×1.8 inch (4.6 cm) having about 0.2 to 0.3 mm wide gold plated line traces with about a 0.2 to 0.3 mm wide gap between each trace, available under the trade designation 250 MLS CROSS-FLEX from T.R.C. Circuits, Inc., Minneapolis, Minn., was used. A piece of electrically conductive, single-sided tape, 40 mm×3 mm, with release liner removed, was then hand laminated to the PCB test panel, such that the length of the tape was perpendicular to the traces and made contact with all of the traces of the PCB panel. After initial hand lamination, a 2 kg rubber roll was rolled across the conductive single sided tape, producing a test panel, FIG. 6. FIG. 6 shows test panel 600 with electrically conductive, single-sided tape 610 and gold plated traces 620. Contact points of various traces were labeled a through q, respectively. After about 20 minutes of dwell time, the D.C. electrical resistance between the adjacent gold plated traces was measured using a Keithley 580 micro-ohmmeter available from Keithley Instruments Inc., Cleveland, Ohio, by placing the ohmmeter leads in contact with the exposed surface of adjacent traces. The electrical resistance was recorded 5 seconds after the leads of the micro-ohmmeter contacted the adjacent traces of the test panel. Multiple adjacent traces were measured, as noted in Table 2, and the average and standard deviation of the data was determined (Table 2).

### Example 1

A conductive porous substrate including a conductive woven fabric and a urethane based black ink coating (opaque coating) that filled a portion of the interstitial regions between the fibers of the woven fabric while have a majority of the electrical contact regions available was obtained under the trade designation BF30 from Truss Ltd., Incheon Kyounggi, Korea and is designated Conductive Porous Substrate A.

A conductive adhesive film was prepared as follows. A monomer premix was prepared, on a weight basis, using 75 parts 2-ethylhexyl acrylate, 25 parts N-vinylcaprolactam and 0.04 parts 2,2-dimethoxy-2-phenylacetophenone photoinitiator (available under the trade designation IRGACURE 651 from BASF Corporation, Florham Park, N.J.). This mixture was partially polymerized under a nitrogen-rich atmosphere by exposure to ultraviolet radiation yielding a syrup having a viscosity of about 3,000 cps. On a weight basis, an adhesive precursor solution was prepared from 100 parts of syrup, 0.1 parts additional 2,2-dimethoxy-2-phenylacetophenone photoinitiator, 0.1 parts 1,6-hexanediol diacrylate and 5.4 parts fumed silica (available under the trade designation AEROSIL R 972 from Evonik Industries, Essen, Germany). The components were mixed together using conventional high shear mixing.

The conductive adhesive film was made by passing a conductive, 28 micron thick polyester, nonwoven scrim coated with multiple, thin layers of metal, nickel/copper/nickel, (available under the trade designation PNW-30-PCN from Ajin-Electron Co., Ltd., Busan, Korea) and the adhesive precursor solution between silicone treated transparent release liners through a conventional two roll coater. The gap between the coater rolls was set at about 40 micron. The coated adhesive precursor solution was cured by UV radiation having an intensity of about 3.0 mW/cm² on both the top side and bottom side of the film. Curing on the top and bottom was conducted simultaneously with exposure to UV radiation for about 520 seconds. After curing, the adhesive precursor solution formed a pressure sensitive adhesive within the pores of the nonwoven scrim.

The release liner was removed from one side of the conductive adhesive film and the exposed surface of the conductive adhesive film was laminated to Conductive Porous Substrate A, Example 1.

### Comparative Example A (CE-A)

Comparative Example A was a conductive fabric tape available under the trade designation DSS-200A-L from DaeSang S.T. Company, Ltd., Chungbuk, South Korea. Excluding the release liner, the conductive fabric tape included three layers, a conductive fabric positioned between a conductive acrylic adhesive and a black coating.

### Comparative Example B (CE-B)

Comparative Example B was an electrically conductive, single-sided tape available under the trade designation 3304BC from 3M Company, St. Paul, Minn. Excluding the release liner, the electrically conductive single sided tape included three layers, a copper foil positioned between a black conductive coating and a conductive, nonwoven embedded adhesive which also includes conductive particles.

Following Electrical Resistance Test Method 1, Electrical Resistance Test Method 2 and Electrical Resistance Test Method 3, the electrical resistance was measured for Example 1, CE-A and CE-B. Results from Test Methods 1 and 2 are shown in Table 1 and results for Test Method 3 are shown in Table 2. The average and standard deviation of each set of data is shown in the last two rows of each table.

TABLE 1
Electrical Resistance Determined by Test Methods 1 and 2
(values in ohms)

| | Test Method 1 | | | Test Method 2 | | |
|---|---|---|---|---|---|---|
| Sample | Example 1 | CE-A | CE-B | Example 1 | CE-A | CE-B |
| 1 | 0.111 | 0.312 | 0.054 | 0.156 | 0.294 | 0.061 |
| 2 | 0.105 | 0.295 | 0.046 | 0.204 | 0.256 | 0.069 |
| 3 | 0.095 | 0.265 | 0.059 | 0.222 | 0.259 | 0.078 |
| 4 | 0.078 | 0.246 | 0.048 | 0.165 | 0.195 | 0.092 |
| 5 | 0.178 | 0.321 | 0.065 | 0.169 | 0.235 | 0.077 |
| 6 | 0.089 | 0.299 | 0.051 | 0.184 | 0.232 | 0.047 |
| 7 | 0.095 | 0.245 | 0.041 | 0.195 | 0.246 | 0.056 |
| 8 | 0.125 | 0.311 | 0.049 | 0.188 | 0.259 | 0.062 |
| 9 | 0.101 | 0.265 | 0.045 | 0.199 | 0.274 | 0.059 |
| 10 | 0.089 | 0.35 | 0.045 | 0.188 | 0.234 | 0.070 |
| Average | 0.107 | 0.291 | 0.050 | 0.187 | 0.248 | 0.067 |
| Std Dev | 0.028 | 0.035 | 0.007 | 0.020 | 0.027 | 0.013 |

TABLE 2
Electrical Resistance Determined by Test Method 3 (vaues in ohms)

| Contacts | Example 1 | | | Comparative Example A | | | Comparative Example B | | |
|---|---|---|---|---|---|---|---|---|---|
| (see | Test | Test | Test | Test | Test | Test | Test | Test | Test |
| FIG. 6) | Panel 1 | Panel 2 | Panel 3 | Panel 1 | Panel 2 | Panel 3 | Panel 1 | Panel 2 | Panel 3 |
| c & d | 0.395 | 0.432 | 0.511 | 2.4 | 21.0 | 19.2 | 0.489 | 0.445 | 0.309 |
| d & e | 0.512 | 0.466 | 0.456 | 2.5 | 5.0 | 1.8 | 0.385 | 0.859 | 0.316 |
| e & f | 0.432 | 0.386 | 0.412 | 6.1 | 6.2 | 2.9 | 0.436 | 0.687 | 0.379 |
| g & h | 0.422 | 0.453 | 0.345 | 10.6 | 11.1 | 5.8 | 0.720 | 0.438 | 0.508 |
| h & i | 0.454 | 0.532 | 0.451 | 3.5 | 1.9 | 16.5 | 0.723 | 0.529 | 0.670 |
| i & j | 0.681 | 0.512 | 0.466 | 15.6 | 12.0 | 3.9 | 0.603 | 0.537 | 0.641 |
| j & k | 0.429 | 0.487 | 0.435 | 6.6 | 2.5 | 10.3 | 0.704 | 0.584 | 0.499 |
| l & m | 0.495 | 0.471 | 0.481 | 6.7 | 8.2 | 5.9 | 0.501 | 0.459 | 0.459 |
| m & n | 0.433 | 0.422 | 0.478 | 8.5 | 5.4 | 12.3 | 0.500 | 0.654 | 0.474 |
| o & p | 0.495 | 0.378 | 0.612 | 20.1 | 22.0 | 9.8 | 0.453 | 0.796 | 0.405 |
| Average | 0.475 | 0.454 | 0.465 | 8.3 | 9.5 | 8.8 | 0.551 | 0.599 | 0.466 |
| Std Dev | 0.082 | 0.050 | 0.069 | 5.8 | 7.1 | 5.9 | 0.126 | 0.147 | 0.122 |

The data in Table 2 shows that the electrically conductive single-side tape of the present disclosure, Example 1, has surprisingly improved (lower) electrical resistance than both a conductive fabric based tape, CE-A, and a metal foil based tape CE-B. Additionally, the surprisingly lower standard deviation in the data of Example 1, compared to CE-A and CE-B is expected to lead to improved reliability in end-use applications. The improvement may be particularly beneficial in providing electrical communication via the electrically conductive single-side tapes of the present disclosure when used in bonding applications which include small electrical contact regions, in for example, a circuit board and the like.

Although the present invention has been described with reference to preferred embodiments, workers skilled in the art will recognize that changes may be made in form and detail without departing from the spirit and scope of the invention.

1. An electrically conductive, single-sided tape comprising:
a conductive adhesive layer comprising:
a first conductive porous substrate having a plurality of passageways; and
an adhesive material positioned within at least a portion of the passageways; and
a second conductive porous substrate having first and second major surfaces and a plurality of passageways, wherein the second major surface of the second conductive porous substrate is positioned adjacent the conductive adhesive layer.

2. The electrically conductive, single-sided tape of claim 1, wherein the second conductive porous substrate comprises a conductive woven or nonwoven fabric having conductive fibers, wherein the conductive fibers comprise electrical contact regions and interstitial regions between the fibers.

3. The electrically conductive, single-sided tape of claim 2, further comprising an opaque coating disposed in at least a portion of the interstitial regions between the fibers.

4. The electrically conductive, single-sided tape of claim 1, wherein the electrical resistance, as measured by Test Method 3, is less than about 8 ohms.

5. The electrically conductive, single-sided tape of claim 3, wherein the opaque coating is non-electrically conductive.

6. The electrically conductive, single-sided tape of claim 3, wherein greater than 50% of the opaque coating is in the interstitial regions adjacent the first major surface of the second conductive porous substrate.

7. The electrically conductive, single-sided tape of claim 3, wherein a portion of the electrical contact regions is substantially free of the opaque coating.

8. The electrically conductive, single-sided tape of claim 3, wherein greater than 30% of the electrical contact regions coincident with the first major surface, based on the total area of the electrical contact regions coincident the first major surface, are substantially free of the opaque coating.

9. The electrically conductive, single-sided tape of claim 2, wherein the conductive fibers are conductive composite fibers.

10. The electrically conductive, single-sided tape of claim 1, further comprising an opaque coating disposed on at least a portion of the first major surface of the second conductive porous substrate.

11. The electrically conductive, single-sided tape of claim 10, wherein the opaque coating is an opaque polymeric film.

12. The electrically conductive, single-sided tape of claim 1, wherein the adhesive material is a conductive adhesive material.

13. The electrically conductive, single-sided tape of claim 1, wherein the first conductive porous substrate is a conductive nonwoven substrate and the second conductive porous substrate is a conductive woven or conductive nonwoven substrate.

14. The electrically conductive, single-sided tape of claim 1 wherein the first conductive porous substrate comprises conductive fibers.

15. The electrically conductive, single-sided tape of claim 14, wherein a portion of the conductive fibers of the first conductive porous substrate protrude from at least one major surface of the conductive adhesive layer.

16. The electrically conductive single-sided tape of claim 3, wherein a portion of the conductive fibers of the second porous substrate protrude through the opaque coating.

17. The electrically conductive single-sided tape of claim 1, wherein the conductive single-sided tape is between about 15 um and about 150 μm thick.

18. The electrically conductive single-sided tape of claim 1, wherein the adhesive material is a pressure sensitive adhesive material.

19. The electrically conductive, single-sided tape of claim 1, wherein the conductive adhesive layer comprises a first adhesive layer and a second adhesive layer.

20. The electrically conductive, single-sided tape of claim 1, wherein the passageways of the first conductive porous substrate are filled with adhesive material such that the conductive porous substrate includes less than about 10% voids by volume.

21. An assembly comprising:
a first substrate having a first surface; and
an electrically conductive single-sided tape according to claim 1, wherein the first surface of the first substrate is bonded to the conductive adhesive layer of the electrically conductive single-sided tape.

22. The assembly of claim 21, further comprising a second substrate, wherein the second substrate is positioned adjacent to and in electrical communication with the second conductive porous substrate of the electrically conductive single-sided tape.

23. The assembly of claim 22, wherein at least one of the first and second substrates of the assembly are electrically conductive.

24. An assembly comprising:
a first substrate having a first surface;
a first layer of an electrically conductive single-sided tape according to claim 1, wherein the first surface of the first substrate is bonded to the conductive adhesive layer of the first layer of electrically conductive single-sided; and
a second layer of electrically conductive single-sided tape according to claim 1, wherein the second conductive porous substrate of the first layer of electrically conductive single-sided tape is bonded to the conductive adhesive layer of the second layer of electrically conductive single-sided tape.
